(19) United States
(12) Patent Application Publication
(10) Pub. No.: US 2002/0174188 A1
(43) Pub. Date: Nov. 21, 2002

(54) Method and apparatus for exchanging contact information

(75) Inventors: Kevin Clark, Chicago, IL (US); Tze-John Tang, Chicago, IL (US); Vladimir Tokarskiy, Chicago, IL (US)

Correspondence Address: Mr. Kevin W. Clark, c/o Objectsoft, Inc., 750 North Clark, Chicago, IL, 60610, US

(73) Assignee: Objectsoft, Inc., Chicago, IL

(21) Appl. No.: 10/135,680

(22) Filed: Apr. 30, 2002

Related U.S. Application Data
(60) Provisional application No. 60/287,180, filed on Apr. 30, 2001.

(51) Int. Cl. G06F 15/167

(52) U.S. Cl. 709/213; 709/206

(57) ABSTRACT

A method and apparatus for exchanging personal contact information with another person or group over a network. The personal information may include, but not limited to, work address, work phone, home address, home phone, cell phone numbers, email addresses, interests, hobbies, pictures or other pertinent information. Personal contact information is stored in a database and there is one to many contact profiles that a user can exchange. Using access to a network with, but not limited to, a computer, PDA, phone or other device, a person may request that one profile be sent to another party. The receiving party receives the profile in a location like a mailbox that they may attach some personal notes, set a follow up activity and then save the new contact in a database for future reference.

### CROSS REFERENCE TO RELATED APPLICATIONS

This application claims priority based on U.S. Provisional Patent Application Serial No. 60/287,180, entitled “Method and apparatus for exchanging contact information” filed Apr. 30, 2001.

### COPYRIGHT STATEMENT

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF INVENTION

The present invention relates to a method and apparatus for exchange of personal information over the Internet. It can be used in a variety of ways including cell phones, pages, PDA and other web sites. Rather than store contact information on a device or a computer for exchange, the present invention allows users to store contact information on computers attached to the Internet and share contact information with other computers, phones, PDAs or devices connected to the Internet without having to be in proximity to the other person.

In addition, sharing can occur by copying information or by sharing a reference to a contact record. References have the distinct advantage of being able to update themselves with the latest information from the Internet.

### Related Prior Art

While some personal digital assistants (PDAs) can beam and exchange of information to each other. This is a personal exchange of information between two devices. It does not allow for update without proximity of two devices and it does not enable automatic update of information based on a shared central database.

### SUMMARY OF INVENTION

It is an object of the invention to provide a software product and/or service to facilitate the exchange of personal information between people. It is meant to remove the manual process of writing down on a piece of paper another persons information or exchanging business cards and then entering this information into a computer.

This will allow two people that meet, to exchange a simple phone number or email address with a pin to exchange details like home contact information, work contact information, hobbies, interests, and more. The present invention provides a method and apparatus to exchange information over the Internet or other transport mediums. The present invention also makes it possible for a person to easily exchange or send information to another person without being in close proximity.

### BRIEF DESCRIPTION OF DRAWINGS

FIG. 1A is a system diagram showing the communications between various senders and receivers.

FIG. 1B is a detailed block diagram of the server architecture of the invention.

FIG. 1C is a detailed block diagram of the send/exchange module of the invention.

FIG. 1D is a detailed block diagram of profile exchanges between clients with software to send and receive profiles.

FIG. 2A is a flow diagram of the sending processes of the exchange.

FIG. 2B is a flow diagram of receiving process of the exchange.

FIG. 3A is a flow diagram illustrating the process of registering a user with the system.

FIG. 3B is a flow diagram illustrating the process of viewing and storing incoming profiles.

FIG. 3C is a flow diagram illustrating the process of choosing a profile from a transmission history log and sending the selected profille to a desination address.

FIG. 4A is a flow diagram illustrating the process of creating profiles.

FIG. 4B is a flow diagram illustrating the process to edit existing profiles.

FIG. 4C is a flow diagram illustrating the process to copy a profile for editing.

FIG. 5 is a flow diagram illustrating the process of activating, deactivating and organizing profiles.

### DETAILED DESCRIPTION

The present invention is directed at providing a better process for exchanging personal information between two or more persons. Briefly described, the program allows a user to create one or many personal profiles that they will use when giving information about themselves to others. These personal profiles may include phone numbers, addresses, notes, pictures, schedule information, hobbies, interests or other pertinent information. The invention also allows for receipt of profiles in the exchange with a efficient means to file new contact information into a database locally or remotely for use at a later time.

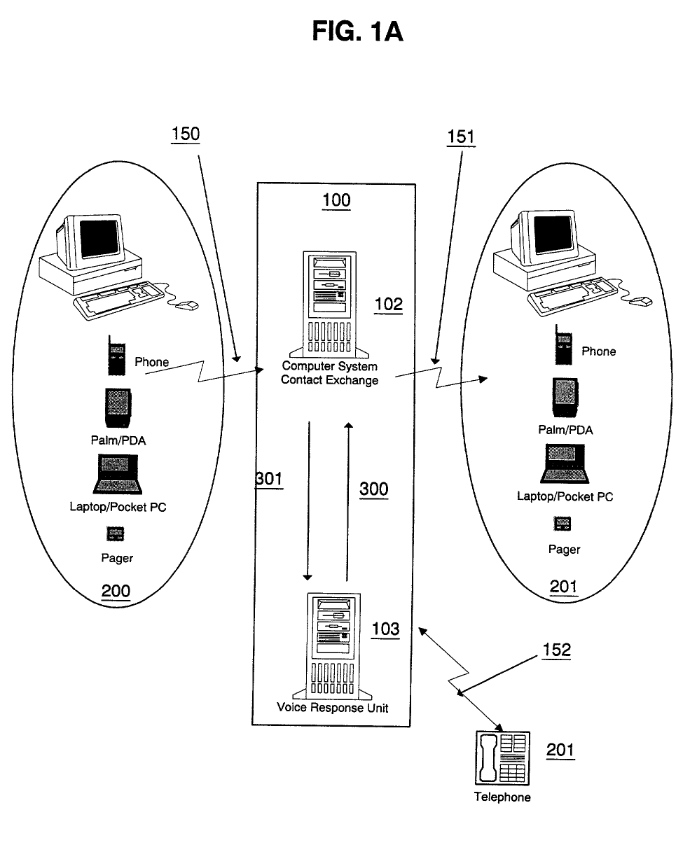

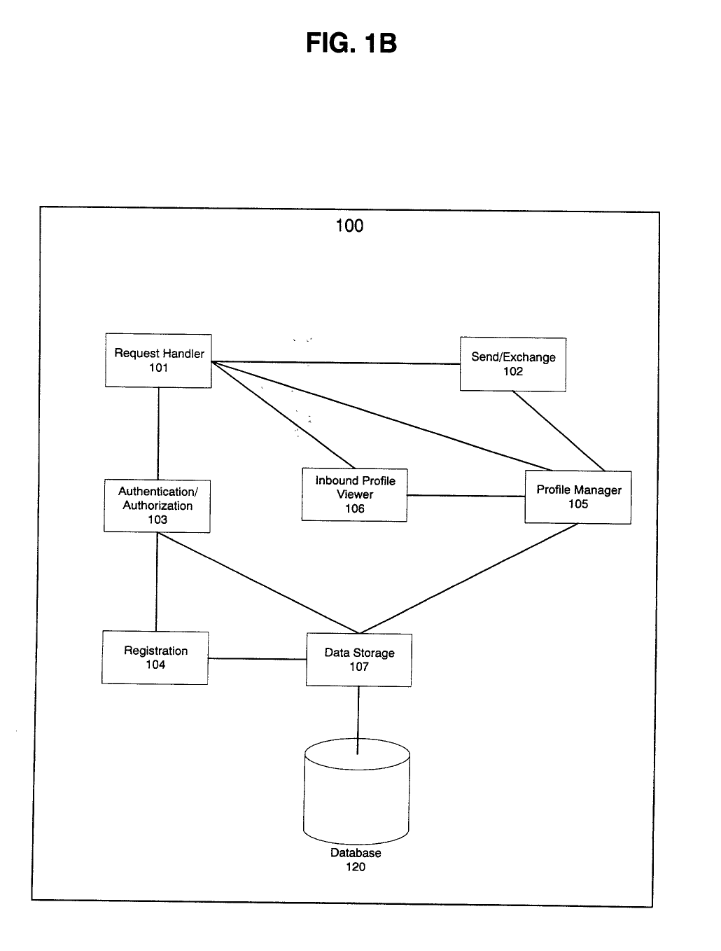

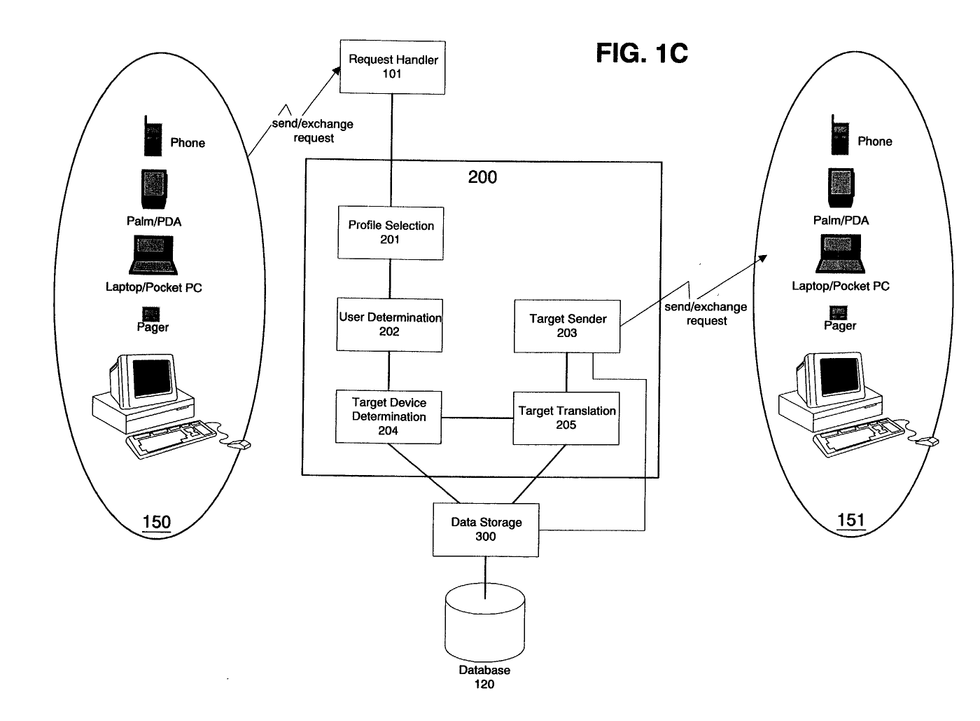

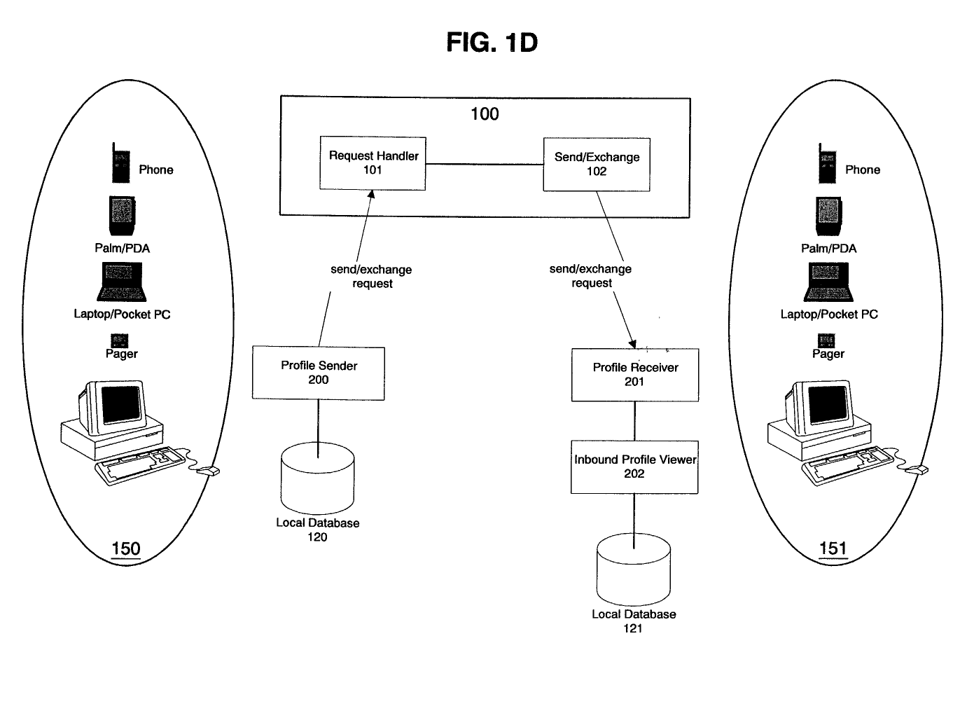

FIG. 1A and the following discussion are intended to provide an overview of the computing environment in which the invention may be implemented. While the program will be described in the general context of an application program that runs in an operating system in conjunction with personal computers, hand-held devices, and telephones, those skilled in the art will recognize that the invention also may be implemented in combination with other program modules. Generally, program modules include routines, programs, components, data structures, etc. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced utilizing standard telephone systems as a terminal to respond to and generate requests to the application program. The invention may also be practiced in distributed computing environments where tasks are performed by remote processing devices that are linked through a communications network. In a distributed environment, program modules may be located in both local and remote memory storage systems.

Referring now to the drawings wherein like reference numerals refer to like elements, FIG. 1A illustrates a contact exchange system 100 which comprises a computer system acting as a contact exchange server 102 and may include a voice response unit 103 to respond to voice commands using standard telephones 201 or wireless phones. A user sending a profile may utilize a computer or other devices 200 to send it to other people over a transport medium 150 utilizing the contact exchange server 102. The contact exchange server 102 will, in turn, communicate with destination computers or devices 201 to deliver the profile information directly or notify the destination user so the profile can be fetched from the contact exchange server 102 using a transport medium 151 or stored on the contact exchange server.

And in FIG. 1A, the transport mediums 150 and 151 preferably using Internet Protocols (IP). A client system 200 can be any device that connects to the system 100 via the Internet or other transport methods that may include, but is not limited to, televisions, computers, hand-held electronic devices, wireless electronic devices, and in point of fact, any device that uses an electronic transport medium. Non-limiting examples of the transport medium 150 and 151 include any backbone or link such as an ATM Link, FDDI Link, satellite link, cable, twisted pair, fiber-optic, broadcast wireless network, the Internet, Local Area Network (LAN), Wide Area Network (WAN), or any other kind of network environment such as a standard Ethernet link. In such alternative cases, the clients will communicate with the system using protocols appropriate for the network which that client is attached.

Also in FIG. 1A, a transport medium 152 may also be a plain old telephone system (POTS) that access the contact exchange system 100 with a voice response unit 103 via a telephone 201. The voice response unit 103 will translate voice and touch-tone commands into requests 300 that the contact exchange server 101 will be able to process. It will also translate responses 301 from the contact exchange server 101 to voice to be heard by users on the telephone 201.

FIG. 1B is a functional block diagram of the software modules of the contact exchange system 100 constructed in accordance with the exemplary embodiment of the present invention. The exchange system 100 includes several major software modules: The request handler 101 handles incoming requests to send and exchange profiles. The send/exchange module 102 manages sending profiles and receiving profiles for exchange. The authentication/authorization module 103 validates the users access to the exchange system 100. The registration module 104 is used to register new users to the system. The profile manager module 105 is used to manage profiles for a user. The profile viewer module 106 is used to display incoming profiles and manage the users organization of incoming profiles. The data storage module 107 is used by other modules to store data to the database 120. The request handler module 101, profile send/exchange module 102, authentication/authorization module 103, registration module 104, profile manager module 105, inbound profile viewer module 106 and data storage module 107 are used with a database 120. Each of these modules are discussed in detail below.

Also in FIG. 1B, the request handler module 101 receives send and exchange requests from users. It utilizes authentication/authorization module 103 to validate the user. If the user is not recognized, the registration module 104 is used to register a new user in the contact exchange system 100. All modules utilize a data storage module 107 to interact with the database 120. Once the user is verified, the request handler module 101 will utilize the profile manager module 105 to select the profile information to send. Once selected, the request handler module 101 will forward the selected profile to the send/exchange module 102 which will, in turn, deliver the profile information to the target destination.

And in FIG. 1B, the send/exchange module 102 is responsible for sending profiles and receiving profiles in exchange from target users. It interacts with target users with e-mail and messages to send and receive profiles. Receivers of the profile can respond back with their own profile information or by invoking an action on the exchange system 100 that will send a profile directly from the database 120 to the original sender which will complete the exchange. The last option is only available to users who have entered profile information in the contact exchange system 100.

In FIG. 1B, the inbound profile viewer module 106 allows the registered users to view incoming profiles sent to them and choose to return a profile back to the sender. The inbound profile viewer module 106 utilizes the authentication/authorization module 103 to verify user before allowing them to view inbound profiles. The profile manager module 105 is used to access the profiles in the database 120 via the data storage module 107.

FIG. 1C is a detailed functional block diagram of the send/exchange module. The send/exchange module 200 is invoked from the request handler module 101. The initial send/exchange request is invoked by the sender utilizing PCs or other devices 150. The request is managed by the send/receive module 200. The profile selection subsystem 101 allows the user to enter a new profile or elects and existing profile.

Referring to FIG. 1C, once the profile is selected, the target is determined from information in the send/exhchange request. The target determination subsystem 203 attempts to match the destination information from the request with existing users in the database 120. If information about the target is located, the profile will be translated by the target translation subsystem 204 into the format that can be accepted by the target computer or device 151. Once translated, the profile is passed to the target sender subsystem 202 for transmission.

Also in FIG. 1C, the target sender subsystem 202 determines how to deliver the profile to the target computers or devices 151. The target sender may send links to profiles that are stored in the database 120 or it may send the profile directly to target systems 151.

FIG. 1D is a functional block diagram of the present invention in the client/server architecture. Those skilled in the art will recognize that many of the modules and subsystems are the same. What differs is the means that the profile is selected or assembled. In a client/server architecture, the client systems 150 and 151, have memory and permanent storage to save profile information. A profile sender module 200 may reside on the client systems 150 allowing the sender to create and select personal profile information and optionally store it in a local database 120. The profile sender 200 sends the profile with a request to the contact exchange system 100 which, in turn, utilizes the send/exchange module 102 to deliver the information to target clients 151.

In FIG. 1D, the target client systems 151, may have memory and permanent storage and may be able to operate a module referred to in FIG. 1D as the profile receiver 201. The profile receiver 201 receives a profile and may store it in a local database 121. It may also choose to automatically respond back to the sender with profile information if the target user decides this is what they want to occur. The target user on target systems 151 may also review incoming profiles using the inbound profile viewer module 202. When reviewing profiles, they may choose to save the profile in the local database 121, forward, delete the incoming profile or respond to the sender.

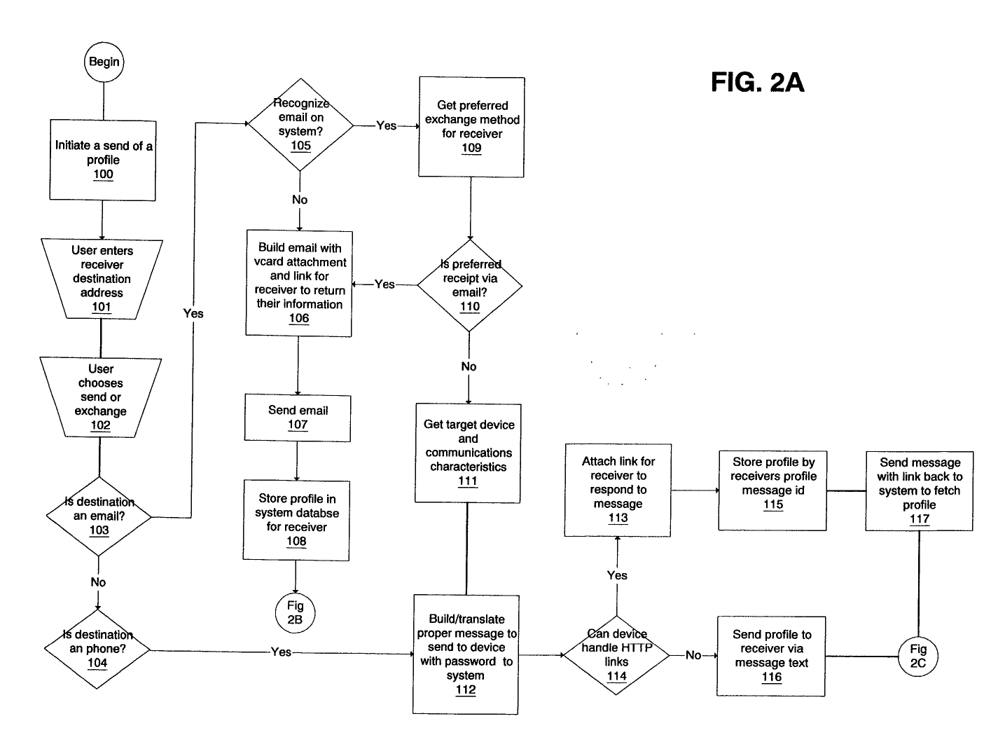

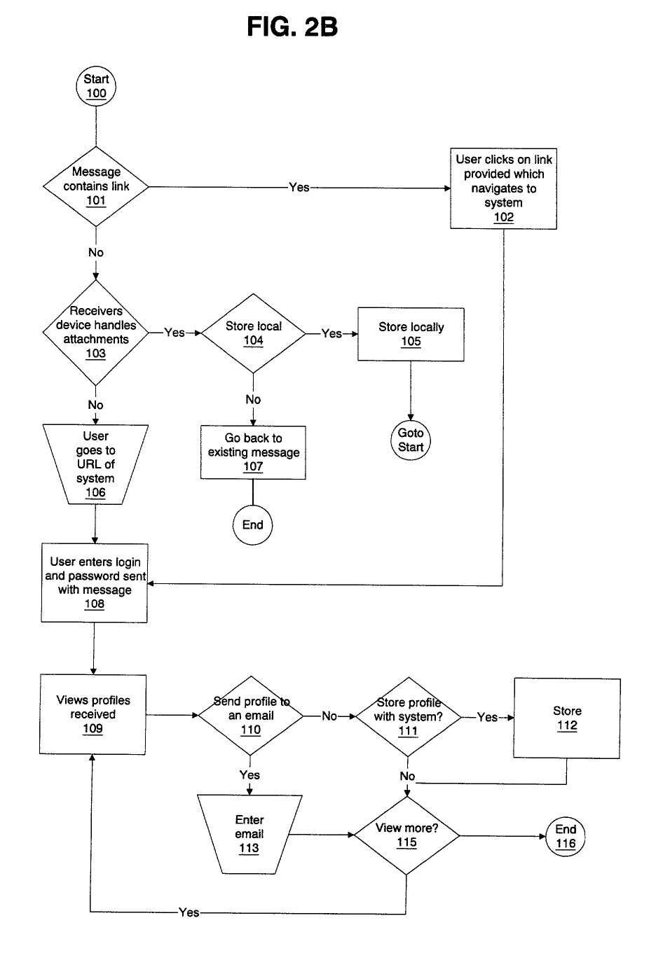

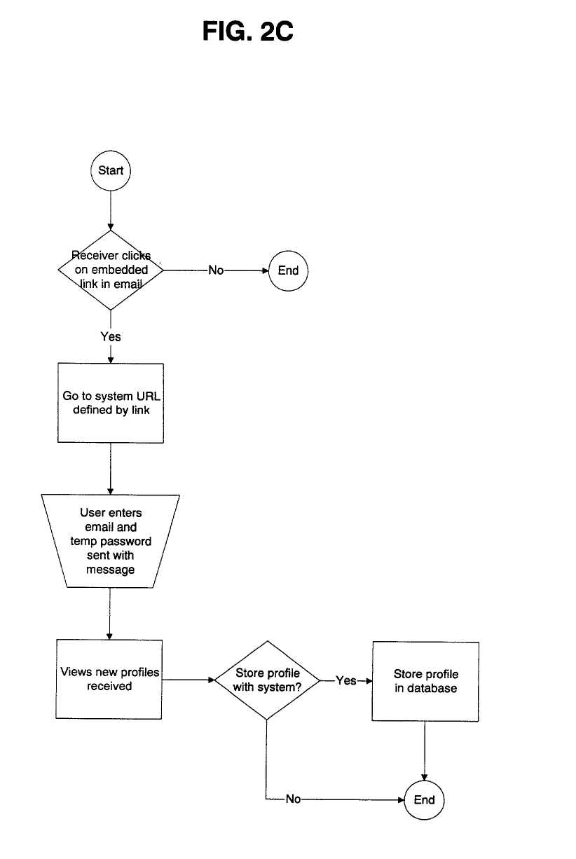

FIG. 2A is a flowchart of the send profile process. In this process the sender initiates a send of a profile 100 by choosing a profile to send. The user then enters the destination address 101, such as a email or phone number, and chooses an option to send or exchange 102. The system may attach timestamp, geographic or determined location information to the outbound profile that will be used by the receiver as context for the exhchange of information. The request is sent to the contact exchange system which determines if the destination is an email 103 or a phone number 104.

Referring to FIG. 2A, if the destination is a email address, the system will check to see if the email address matches a registered user of the system 105. If no match is found, the system will assemble an email with the profile information and link back to the system so the receiver may fetch the profile. The system may attach a standard representation such as a vcard to the email that represents the profile 106. The system will send the email 107 and store the sent profile, or a reference to the profile, in the system database 108 to be retrieved at a later time by the receiver.

Referring also FIG. 2A, if the email address is recognized as a user on the system 105, the system will then attempt to determine the preferred method of exchange for profiles 109. If the preferred method of exchange is email, the process described in paragraph 0033 will be enacted. If some other communication is preferred, the system will determine the characteristics of the target destination and characteristics of the communication means 111. Using this information, the system will consist of the appropriate data to send to the target device over some means of communication 112.

In FIG. 2A, if the target device can process HTTP links 114, the system will attach a link to the message 113 that can be used by the receiver to fetch the sent profile. The system will store the profile 115, or some reference to the profile, that will be used later by the receiver. Once the message is compiled and the profile is stored, the message is sent 117. If the target device cannot process HTTP links 114, the system will convert the message and profile to text and send it to the receiver 116.

FIG. 2B is a flowchart of the receive profile process. In this process a message is received 100 which starts the process. If the message contains a link that the receivers device or computer can understand 101, the user may select that link 102 to navigate the the contact exchange system. If the message does not contain a link, but contains an attachment the device or computer can recognize 103, then the user is presented with the option to store the profile locally 104. If the user chooses not to store the profile locally, the user will be shown the same message again 107 and the process with restart 100. If the user stores the message locally 105, the process ends. If the user chooses not to store the message locally 104, then the process will return to the same message 107 and the process will restart 100.

Also in FIG. 2B, if the receivers device or computer cannot receive attachments of profiles 103, the user may, if their computer or device allows them to, go to the location of the contact exchange system 106 on the network. Once receivers invoke the contact exchange system, they may use their login ID and password sent with the message 108 to access the system and view incoming profiles. When viewing profiles, the user may forward the profile to a unique address email or phone number 110, store the profile locally 111 or take no action on the profile . The user may view more profiles 115 if no action is taken. If the user chooses to foward the profile information to email address or phone number, they enter the address 113 and confirm the send. After sending the profile, the may view other incoming profiles 115.

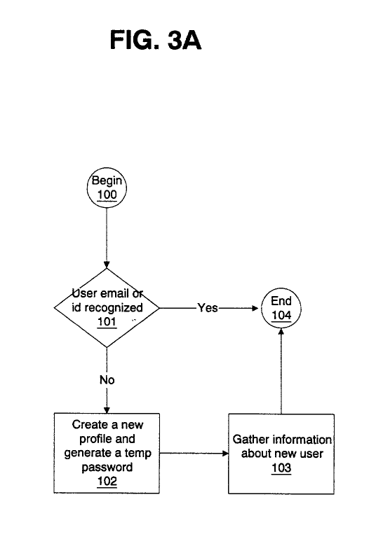

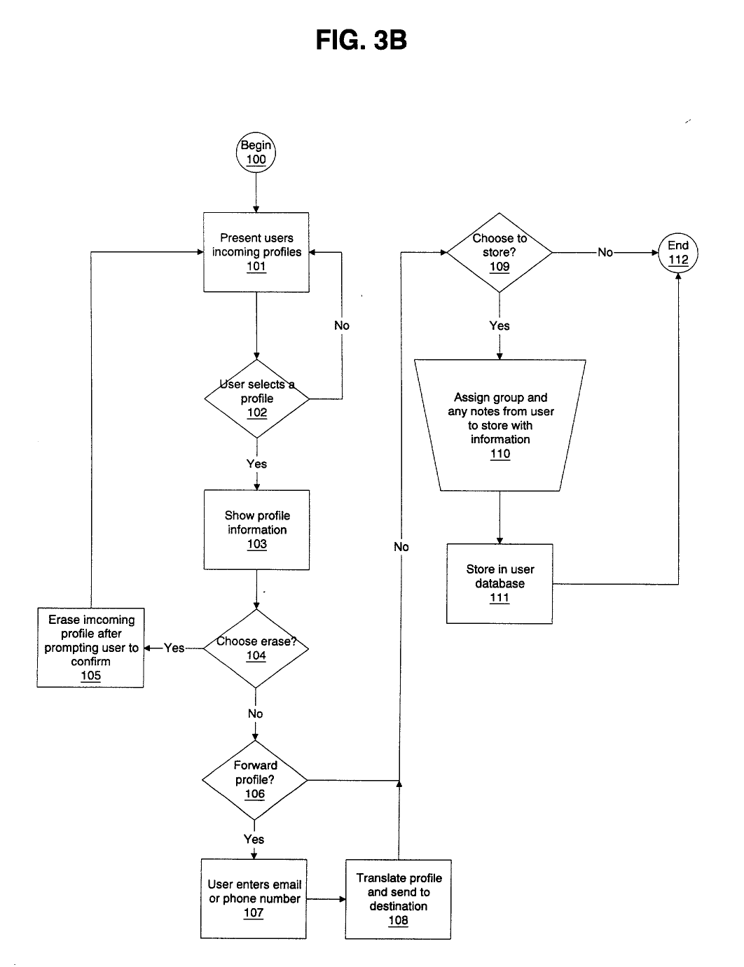

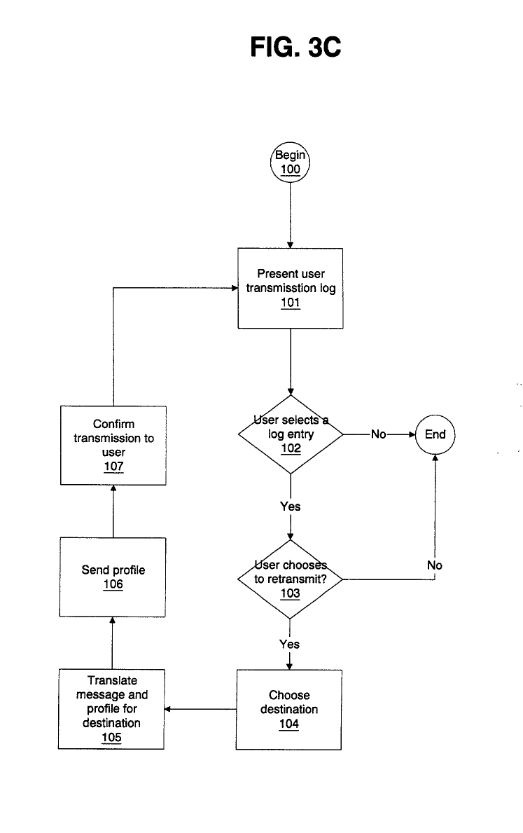

FIG. 3A is a flowchart of the registration process. This process begins at 100 after the users email or some other id, perhaps a phone number, is gathered. If the email or id is recognized as a user of the system 101, the user is already member and this process terminates 104. If the user is not recognized, the system will create a new profile and generate a new password for the user 102. The user may complete a profile with information about themselves 103, including, but not limited to, name, addresses, phone numbers, important dates and pictures.

FIG. 3B is a detailed flowchart of the incoming profile review process. This process begins at 100 after the receiver has invoked the contact exchange system to review incoming profiles. The user is presented with incoming profiles 101 so they may select a profile 102. When the user selects a profile, they are shown the information about the profile 103 and have the option to erase, forward or store the profile. If the user chooses to erase the profile 104, a confirmation dialog will confirm their action and then return them to the list of incoming profiles 101.

Also in FIG. 3B, if the user chooses to forward the profile 106, they will be prompted to enter a email address or phone number 107. The contact exchange system will then translate the profile to be understood by the target destination and send the translated profile 108. The user can then opt to store the profile locally 109 as described in the following paragraph 0042.

And in FIG. 3B, if the user chooses to store the profile 109, they may assign the profile to a group and add notes 110. Assignment to a group will allow a user to organize contact profiles in the database for easier location and access. Adding notes will allow a user to add context to the exchange of the profiles. For example, they might write a quick description of the person or about where they met the person. After this information is entered, the profile and additional information entered by the user is stored in a database 111.

FIG. 3C is a flowchart of the resend process. User may choose to resend a profile by viewing a transmission log 101 and selecting a profile 102. After the user selects the profile, they can choose to retransmit the profile 103. If they choose to retransmit, the user can choose a destination 104 to send the profile. Once the destination is selected the contact exchange system will translate the profile and message to the appropriate format for the destination 105 and send the translated message 106. Users will be given a confirmation message after the profile is sent 107 and returned to the transmission log 101.

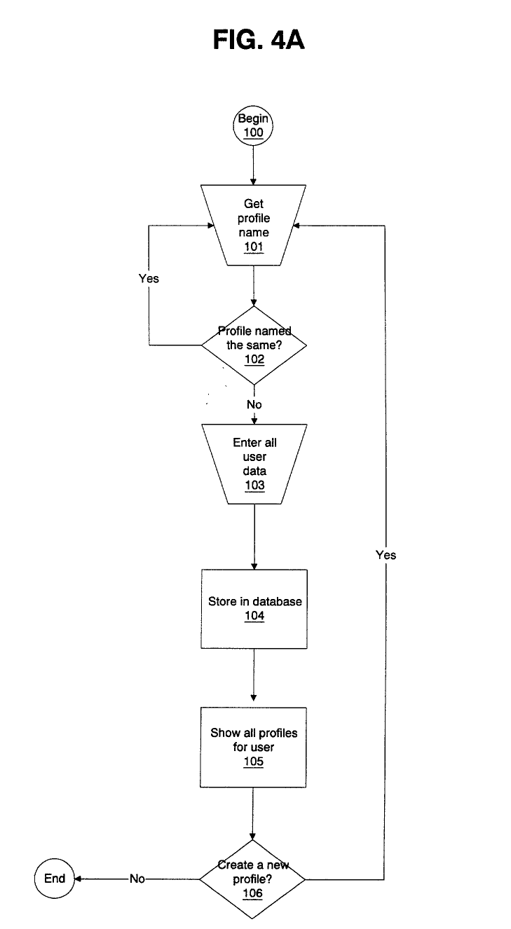

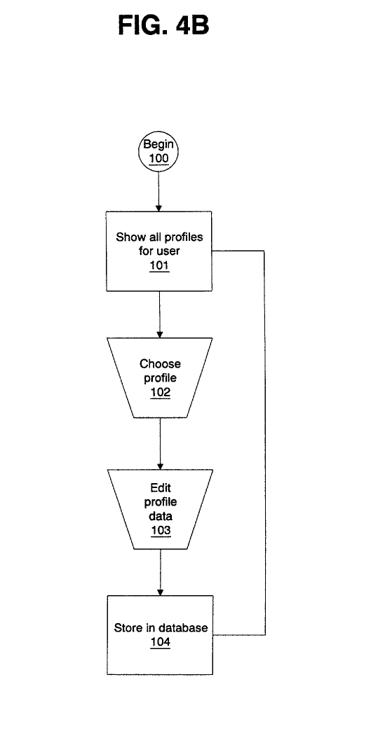

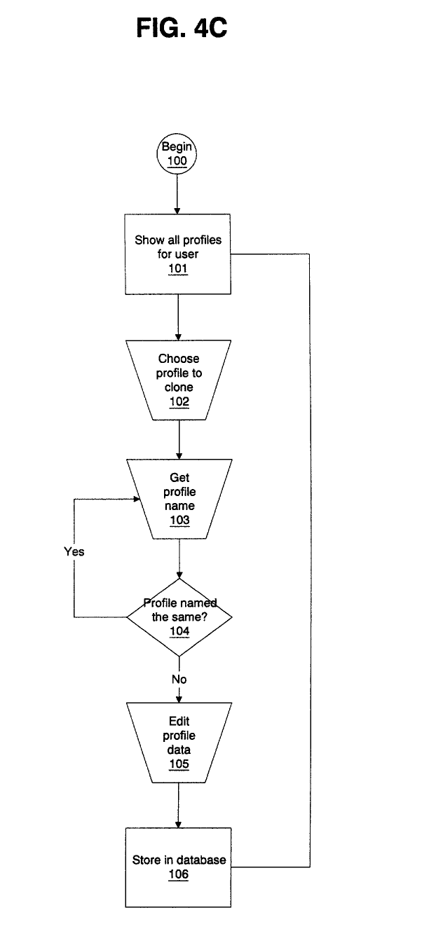

FIG. 4A is a flowchart of the profile creation process. Profile creation is the process that a user implements to define and name a profile with information and name it for future use. The process begins on the contact exchange system when the user enters the profile creation module 100 and chooses to create a new profile. The user is presented with a screen that allows them to enter the profile name 101. If the profile name exists 102, the user is required to enter another name. Once a name is choosen, the user enters the profile data 103 including, but not limited to, phone numbers, addresses, important dates, pictures and notes. The user profile is saved in the system database 104. After the process is complete, a list of all profiles are presented 105 and the user can choose to create another profile 106.

FIG. 4B is a flowchart of the profile edit process. This process is invoked by users of the system to edit the information in a profile. A user enters the process at 100 and views all their profiles in the system 101. The user can choose a profile 102 and edit the profile data 103. Once the data is edited, the user can cancel the edit or save the profile in a database 104. Users will be returned to the beginning of this process 100.

FIG. 4C is a flowchart of the profile copying process. This process is invoked by users who want to copy profiles and save them under a different name with potentially different information. In this process, the user is presented with a list of all profiles 101. They can choose a profile to copy 102. The system requires the user to enter a new profile name 103 which is validated to be unique 104. The user can then choose to store the new and potentially modified profile in the database 106 and will be returned to an updated list of all profiles 101.

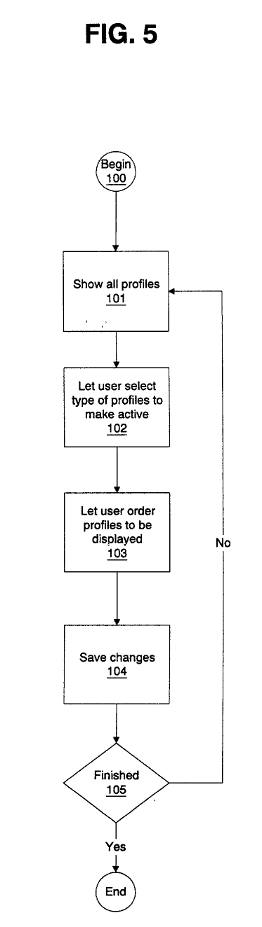

FIG. 5 is a flowchart of the profile activation and ordering process. During this process, users may choose which profiles they wish to ke p active and what order they will be presented. The user can select one to many profiles in the list and activate or deactivate 102. Also, they may choose to reorder the list of active profiles 103. After the user has made changes, they may save the changes 104 and return to the updated list of profiles 101.

1. A system for transferring personal data from one user to another through a transmission protocol providing:
a means to store user data profiles containing information about the user including, but not limited to, name, addresses, phone numbers, emails, important dates, hobbies, pictures and notes;
a means to send a profile to another person or group of people on the network through a transmission protocol;
a means to select if the sender wishes to receive a profile in return;
a means to view incoming profile data sent to user;
a means to store received user profiles from the network;
a means to allow the user to respond to requests from the network for user profile data.

2. A system of claim 1 further comprising information about:
the user's access to accounts on other remote systems;
the user's computers and devices;
the user's software to facilitate propagation of contact information;
the user's preferred destination to receive new information.

3. A system of claim 1 further comprising:
a means to change or update profiles defined in system;
a means to create different profiles, with potentially different information, and store them by name for later selection;
a means to order different named profiles for selection;
a means to select a profile by name and send it to other people over the network.

4. A system of claim 3 further comprising:
a means for the user to establish default profiles to send when responding to requests for profiles from the network;
a means for the user to establish a password required to be presented when responding to requests for profiles from the network.

5. A system of claim 1 that contains all data and information about users but is not residing on the computer or device of the user.

6. A system of claim 5 that has
a means to store all user information defined in claim 1 or claim 2 on a remote database accessiable from a transmission protocol;
a means to store profiles and contact information for users;
a means for remote users using computers and devices to securely access the remote system and database;
a means for remote users using computers and devices to send profiles from the remote database;
a means for remote users to view received profiles on the remote system;
a means for remote users to delete incoming profiles on the remote system;
a means for remote users to forward incoming profiles to an email or phone number from the remote system;
a means for remote users to save the incoming profile in a contact database on the remote system.

7. A system of claim 5 that can identify the unique user by email or phone number.

8. A system of claim 5 that can rsend and eceive secure and non-secure rmessages, data and profiles

9. A system of claim 5 that may send and receive requests in a markup langauge.

10. A system of claim 5 that may send and receive requests in character format messages.

11. A system of claim 1 or claim 5 that may optionally attach the following information when sending a profile:
geographic location of the sender;
time and date of the transmission;
the physical location (i.e. establishment, street or address) based on geographic information;

12. A system of claim 5 that may notify receivers of new incoming profiles by, but not limited to, email, messaging, voice or fax.

13. A system of claim 12 that allows the user to respond to the notification.

14. A system of claim 13 that allows the user to receive notifications that at hypertext markup language links that will invoke the remote system when activated.

15. A system of claim 6 that allows the user saving a profile from the remote system to:
attach notes to the profile and save in remote or local contact database;
attach a picture to the profile and save in remote or local contact database;
attach a voice memo to the profile and save in a remote or local contact database.

16. A system of claim 6 or claim 15 that allows the user to schedule an activity or reminder with the incoming profile when saved in a database.

17. A system of claim 1 or claim 6 that operates on any network transmission protocol.

18. A system of claim 1 or claim 6 that operates with local network protocols including, but not limited to, infrared, PCS, LAN and 802.11b.
